(19) United States
(12) Patent Application Publication
(10) Pub. No.: US 2024/0429824 A1
(43) Pub. Date: Dec. 26, 2024

(54) QUASI-RESONANT FLYBACK VOLTAGE REGULATOR SYSTEM

(71) Applicant: TEXAS INSTRUMENTS INCORPORATED, DALLAS, TX (US)

(72) Inventor: Isaac Cohen, Dix Hills, NY (US)

(21) Appl. No.: 18/338,327

(22) Filed: Jun. 20, 2023

(51) Int. Cl. H02M 3/335; H02M 1/00

(52) U.S. Cl. CPC H02M 3/33507; H02M 1/0009; H02M 1/0058

(57) ABSTRACT

A circuit includes a switching stage including a primary switch and an input controller. The input controller activates the primary switch to conduct a primary current in a primary winding of a transformer in response to a zero amplitude of a switch voltage at a switching terminal, and can deactivate the primary switch to provide a secondary current in a secondary winding of the transformer based on the primary current. The circuit also includes an output stage that provides an output voltage in response to the secondary current. The output stage includes a secondary switch and an output controller. The output controller activates the secondary switch to conduct a request current in the secondary winding in response to ringing of a primary voltage across the primary winding and the output voltage, and deactivates the secondary switch to provide the reflected current in the primary winding based on the request current.

### TECHNICAL FIELD

This description relates generally to electronic circuits, and more particularly to a quasi-resonant flyback voltage regulator system.

### BACKGROUND

Flyback voltage regulator circuits can be implemented in a variety of different ways. Examples of flyback voltage regulator circuits include synchronous rectifier power converters, asynchronous rectifier power converters, resonant power converters, and any of a variety of other types of switching power converters. A typical flyback voltage regulator circuit can thus activate one or more switches to convert an input voltage to an output voltage. Typical flyback voltage regulator circuits can implement a transformer for delivering an output voltage on the secondary winding of a transformer from a square-wave input voltage applied by the switches to the primary winding of the transformer. Based on the resonant characteristics between the windings of the transformer and circuit component parasitic effects, the current in the primary and secondary windings can exhibit ringing, which can result in an induced voltage ringing on both input switches and output switches.

### SUMMARY

One example includes a circuit. The circuit includes a switching stage including a primary switch and an input controller. The input controller activates the primary switch to conduct a primary current in a primary winding of a transformer in response to a zero amplitude of a switch voltage at a switching terminal, and can deactivate the primary switch to provide a secondary current in a secondary winding of the transformer based on the primary current. The circuit also includes an output stage that provides an output voltage in response to the secondary current. The output stage includes a secondary switch and an output controller. The output controller activates the secondary switch to conduct a request current in the secondary winding in response to ringing of a primary voltage across the primary winding and the output voltage, and deactivates the secondary switch to provide the reflected current in the primary winding based on the request current to reduce the switch voltage to zero.

Another example includes a circuit. The circuit includes a switching stage and an output stage. The switching stage includes a primary switch having a primary switch control input, a primary switch input, and a primary switch output. The primary switch input can be coupled to a first terminal of a primary winding of a transformer. The switching stage also includes an input controller having a switching control input and a switching control output. The control input can be coupled to the primary winding of the transformer and the control output being coupled to the primary switch input. The output stage includes a circuit output and a rectifier diode having an anode and a cathode. The anode can be coupled to the circuit output and the cathode can be coupled to a first terminal of a secondary winding of the transformer. The output stage also includes a secondary switch having a secondary switch control input, a secondary switch output, and a second secondary switch output. The secondary switch output can be coupled to the secondary winding of the transformer and the secondary switch input being coupled to the circuit output. The output stage further includes an output controller having an output control input and an output control output. The output control input can be coupled to the secondary winding of the transformer and the output control output being coupled to the secondary switch control input.

Another example includes a quasi-resonant flyback voltage regulator system. The system includes a transformer comprising a primary winding and a secondary winding and a switching stage comprising a primary switch and an input controller. The input controller can be configured to activate the primary switch to conduct a primary current in the primary winding in response to a switch voltage at a switching terminal having an amplitude of zero, and to deactivate the primary switch to provide a secondary current in the secondary winding based on the primary current. The system further includes an output stage configured to provide an output voltage at an output in response to the secondary current. The output stage includes a secondary switch and an output controller. The output controller can be configured to activate the secondary switch to conduct a request current in the secondary winding in response to ringing of a primary voltage across the primary winding and an amplitude of the output voltage, and to deactivate the secondary switch to provide the reflected current in the primary winding based on the request current to reduce the switch voltage to zero.

### BRIEF DESCRIPTION OF THE DRAWINGS

FIG. 1 is an example of a block diagram of a flyback voltage regulator system.

FIG. 2 is an example of a flow diagram demonstrating operation of a flyback voltage regulator system.

FIG. 3 is an example of a timing diagram.

FIG. 4 is another example of a timing diagram.

FIG. 5 is an example circuit diagram of a flyback voltage regulator system.

FIG. 6 is another example circuit diagram of a flyback voltage regulator system.

FIG. 7 is another example of a timing diagram.

### DETAILED DESCRIPTION

This description relates generally to electronic circuits, and more particularly to a quasi-resonant flyback voltage regulator system. The quasi-resonant flyback voltage regulator system includes a switching stage, an output stage, a transformer interconnecting the switching and output stages, and an input controller. The switching stage includes a primary switch and an input controller. The primary switch is activated to provide a primary current from an input voltage through a primary winding of the transformer and through the primary switch. As described herein, the term “activate”, as describing a transistor, refers to providing sufficient bias (e.g., gate-source voltage for a field-effect transistor (FET)) to operate the transistor device in resistive mode. Similarly, the term “deactivate”, as describing a transistor, refers to removing bias to operate the transistor device in cutoff mode. The output stage includes a rectifier switch and an output controller. The rectifier switch can be arranged as a parallel arrangement of a diode and a switch, or can be arranged as a metal-oxide semiconductor field effect transistor (MOSFET).

The switching stage is configured to activate the primary switch in response to the input controller detecting a zero amplitude of a switch voltage at a switching terminal. After the primary current is provided through the primary winding of the transformer, the primary switch is deactivated to provide a secondary current from ground through the secondary winding of the transformer to a circuit output of the quasi-resonant flyback voltage regulator system. The secondary current charges an output capacitor to provide an output voltage at the circuit output. When the secondary current decreases to zero amplitude, a voltage across the primary winding begins to ring based on a resonator formed by the magnetizing inductance of the transformer and a total capacitance of the switching terminal, such as including a parasitic capacitance of the primary switch and a collective capacitance between the drain of the primary switch and ground. The output controller monitors the ringing of the primary winding as reflected to the secondary winding, and monitors an amplitude of the output voltage. In response to the output voltage decreasing less than a low output voltage threshold, the output controller activates the secondary switch at a specific time in the ringing to provide for zero-volt switching (ZVS) of the secondary switch. As described herein, the terms “zero-volt switching” and “ZVS” refer to activation of a switch (e.g., the primary switch or the secondary switch) with substantially no voltage across the respective switch, and therefore substantially no ON-switching losses.

In response to being activated, the secondary switch begins to conduct a request current from the circuit output through the secondary winding to ground, and thus opposite the direction of the secondary current. The secondary switch can remain activated for a predefined time before deactivation, with the predefined time being an amount of time to build an amplitude of the request current in the secondary winding that is sufficient to be reflected to the primary winding. After the predefined time duration, the secondary switch is deactivated to transfer the request current to the primary winding as a reflected current. The reflected current can be conducted from the switching node through the primary winding of the transformer to the input voltage, and thus opposite the direction of the primary current. The reflected current flows out of the switching terminal, thereby discharging the total capacitance of the switching terminal to reduce the switch voltage to approximately zero.

As described previously, the input controller can be configured to monitor the amplitude of the switch voltage at the switching terminal. Therefore, in response to detecting the zero amplitude of the switch voltage at the switching terminal, the input controller can again activate the primary switch to provide ZVS of the primary switch. Accordingly, the process repeats in this manner, such that the output controller communicates a request to the input controller for the switching stage to provide more power to the output stage based on the currents provided in the transformer.

As described in greater detail herein, the quasi-resonant flyback voltage regulator system can include a control mechanism to ensure that the ringing of the switch voltage does not result in an erroneous activation of the primary switch that can result in loss of the control scheme of the quasi-resonant flyback voltage regulator system. As a first example, the input controller can include circuitry that can provide blanking of at least one trough of the ringing of the switch voltage. As a second example, the output controller can include an additional control loop that can detect the erroneous activation of the primary switch, and can facilitate deactivation of the primary switch to maintain the control scheme for regulating the output voltage. In this manner, the quasi-resonant flyback voltage regulator system can be configured to provide the control scheme in a robust manner, despite variations in the amplitude of the input voltage, as described in greater detail herein.

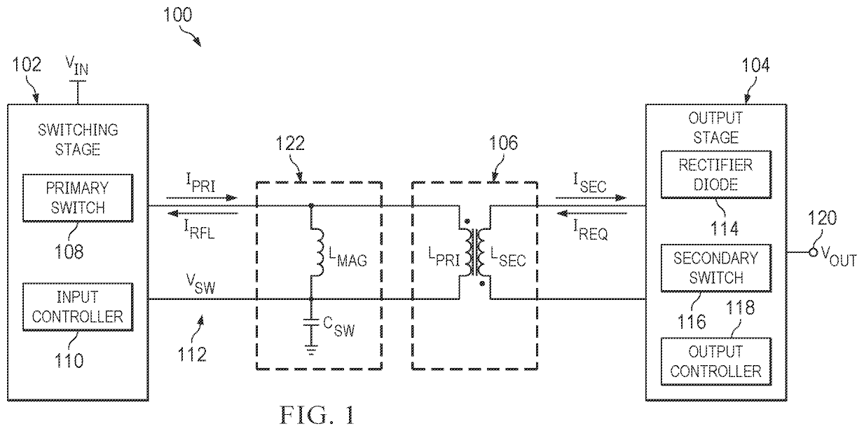

FIG. 1 is a block diagram of a quasi-resonant flyback voltage regulator system 100. The quasi-resonant flyback voltage regulator system 100 can be configured to generate an output voltage V_{OUT} based on an input voltage V_{IN}. The quasi-resonant flyback voltage regulator system 100 can be implemented in any of a variety of direct current (DC) power-providing applications. As an example, portions of the quasi-resonant flyback voltage regulator system 100 can be provided as or as part of an integrated circuit.

The quasi-resonant flyback voltage regulator system 100 includes a switching stage 102, an output stage 104, and a transformer 106. In the example of FIG. 1, the switching stage 102 includes a primary switch 108 and an input controller 110. The primary switch 108 is periodically activated by the input controller 110 to provide a primary current I_{PRI} from the input voltage V_{IN} through a primary winding L_{PRI} of the transformer 106 and through the primary switch 108 to ground. As an example, the input controller 110 can be configured to monitor a switch voltage V_{SW} at a switching terminal 112 that is coupled to the primary switch 108. Thus, in response to the switch voltage V_{SW} having an amplitude of zero, as described in greater detail herein, the input controller 110 can activate the primary switch 108 to provide zero-volt switching (ZVS) of the primary switch 108.

The output stage 104 includes a rectifier diode 114, a secondary switch 116, and an output controller 118. The rectifier diode 114 can be arranged to facilitate the flow of a secondary current I_{SEC} that is induced in the secondary winding L_{SEC} of the transformer 106 and is provided to a circuit output 120 to provide the output voltage V_{OUT} to a load. For example, as described in greater detail herein, the secondary current I_{SEC} can be conducted from ground through the secondary winding L_{SEC} to the circuit output 120 in response to deactivation of the primary switch 108, such as in response to an amplitude of the primary current I_{PRI}, and thus based on the energy in the primary winding L_{PRI} by the primary current I_{PRI}. The secondary current I_{SEC} can thus charge an output capacitor (not shown) to provide the output voltage V_{OUT} at the circuit output 120. While the example of FIG. 1 demonstrates the rectifier diode 114 and the secondary switch 116 as separate devices, as described herein, the rectifier diode 114 and the secondary switch 116 can collectively refer to a metal-oxide semiconductor field effect transistor (MOSFET).

In response to the secondary current I_{SEC} decreasing to the approximately zero, a voltage V_{PRI} across the primary winding L_{PRI} can begin to ring based on a resonator 122 that is formed by a magnetizing inductance L_{MAG} associated with the transformer 106 and by a total capacitance C_{SW} associated with the switching terminal 112. For example, the total capacitance C_{SW} can include a parasitic capacitance of the primary switch 108 and a collective capacitance between the drain of the primary switch 108 and ground. The ringing associated with the voltage V_{PRI} can be reflected to the secondary winding L_{SEC}. The output controller 118 can be configured to monitor the amplitude of the output voltage V_{OUT}, and can monitor ringing at a voltage V_{SEC} across the secondary winding L_{SEC} that is based on the voltage V_{PRI}. In response to detecting the output voltage decreasing less than an output voltage threshold, the output controller 118 can be configured to activate the secondary switch 116. For example, the output controller 118 can activate the secondary switch 116 at a specific time during a period of the ringing associated with the voltage V_{SEC} to provide ZVS of the secondary switch 116.

Upon activation, the secondary switch 116 can conduct a request current I_{REQ} from the circuit output 120 through the secondary winding L_{SEC} of the transformer 106 to ground, and thus in a direction opposite the secondary current I_{SEC}. Thus, the secondary switch 116 can conduct the request current I_{REQ} from the circuit output 120 through the secondary winding L_{SEC} to a low-voltage rail (e.g., ground). As an example, the output controller 118 can be configured to activate the secondary switch 116 for a predefined time duration before deactivation. For example, the predefined time duration can be enough time to build an amplitude of the request current I_{REQ} in the secondary winding L_{SEC} that is sufficient to provide current reflection to primary winding L_{PRI}. After the predefined time duration, the output controller 118 deactivates the secondary switch 116 to transfer a reflected current I_{RFL} to the primary winding L_{PRI} of the transformer 106 opposite the direction of the primary current I_{PRI}. The reflected current I_{RFL}, thus conducts current from the switching terminal 112 through the primary winding L_{PRI} to the input voltage V_{IN}, thereby discharging the total capacitance C_{SW} of the switching terminal 112 to reduce the switch voltage V_{SW} to approximately zero. As described above, in response to the switch voltage V_{SW} having an amplitude of zero, the input controller 110 can activate the primary switch 108 again, thus repeating the process described above.

As described in greater detail herein, the quasi-resonant flyback voltage regulator system 100 can include a control mechanism in the input controller 110 and/or the output controller 118 to ensure that the ringing of the voltage V_{PRI} does not result in an erroneous activation of the primary switch 108 at an improper time, as described in greater detail herein. As a first example, the input controller 110 can include circuitry that can provide blanking of at least one trough of the ringing of the voltage V_{PRI}. As a second example, the output controller 118 can include an additional control loop that can detect the activation of the primary switch 108 at the improper time, and can facilitate deactivation of the primary switch 108 in response. In this manner, the quasi-resonant flyback voltage regulator system 100 can be configured to provide the control scheme in a robust manner, despite variations in the amplitude of the input voltage V_{IN}, as described in greater detail herein.

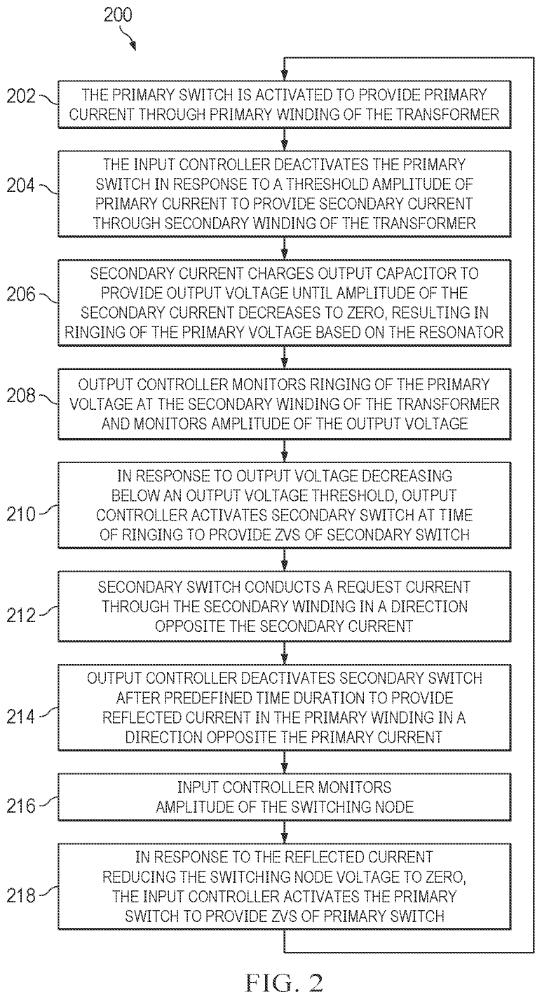

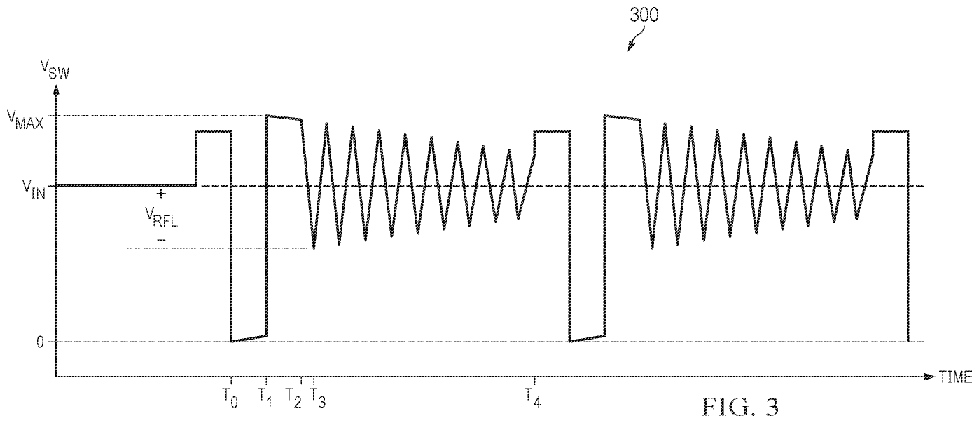

FIG. 2 is an example of a flow diagram 200 demonstrating operation of a quasi-resonant flyback voltage regulator system, such as the quasi-resonant flyback voltage regulator system 100. FIG. 3 is an example of a timing diagram 300, such as corresponding to operation of the quasi-resonant flyback voltage regulator system 100. Reference is to be made to the example of FIG. 1 in the following description of the examples of FIGS. 2 and 3. The timing diagram 300 demonstrates a plot of an amplitude of the switching voltage V_{SW} over time. The timing diagram 300 also demonstrates an amplitude of the input voltage V_{IN} as a constant amplitude, as provided by the dotted line 302.

The flow diagram 200 begins at 202, at which the primary switch 108 is activated in response to the input controller 110 detecting a zero amplitude of a switch voltage V_{SW} at the switching terminal 112. In the timing diagram 300, the step 202 occurs at a time T₀ in which the switch voltage V_{SW} decreases to zero. Therefore, the primary current I_{PRI} is provided through the primary winding L_{PRI} of the transformer 106. The switch voltage V_{SW} begins to slightly increase after the time T₀ in the timing diagram 300 based on the charging of the total capacitance C_{SW} of the switching terminal 112. At 204, the input controller 110 deactivates the primary switch 108 in response to an amplitude of the primary current I_{PRI} exceeding a threshold current amplitude to transfer the secondary current I_{SEC} to the secondary winding L_{SEC} of the transformer 106. In the timing diagram 300, the step 204 occurs at a time T₁ in which the switch voltage V_{SW} increases significantly to an amplitude V_{MAX}.

At 206, the secondary current I_{SEC} charges the output capacitor that provides the output voltage V_{OUT} at the circuit output 120 until the amplitude of the secondary current I_{SEC} decreases to approximately zero, resulting in ringing of the primary voltage V_{PRI} based on the resonator 122. The ringing of the primary voltage V_{PRI} can result in ringing of the switch voltage V_{SW}, as well as the secondary voltage V_{SEC}. In the timing diagram 300, the step 206 occurs at a time T₂ in which the switch voltage V_{SW} decreases significantly. In the example of FIG. 3, the switch voltage V_{SW} decreases to an amplitude that is less than the input voltage V_{IN} by a reflected voltage amplitude V_{RHL} at a time T₃. The ringing of the switch voltage V_{SW} continues to oscillate about the input voltage V_{IN} after the time T₃.

At 208, the output controller 118 monitors the ringing of the primary voltage V_{PRI} at the secondary winding L_{SEC} of the transformer 106 and monitors an amplitude of the output voltage V_{OUT}. At 210, in response to the output voltage V_{OUT} decreasing less than an output voltage threshold (e.g., a low output voltage threshold), the output controller 118 activates the secondary switch 116 at a specific time in the ringing to provide for ZVS of the secondary switch 116. In the example of FIG. 3, the secondary switch 116 is activated at a time T4. At 212, in response to being activated, the secondary switch 116 begins to conduct a request current I_{REQ} from the circuit output 120 through the secondary winding L_{SEC} opposite the direction of the secondary current I_{SEC}.

At 214, after the predefined time duration, the secondary switch 116 is deactivated to transfer a reflected current I_{RFL} to the primary winding L_{PRI} of the transformer 106 opposite the direction of the primary current I_{PRI}. The reflected current I_{RFL} is thus conducted from the switching terminal 112, thereby discharging the total capacitance C_{SW} of the switching terminal 112 to reduce the switch voltage V_{SW} in the switching terminal 112 to approximately zero. At 216, the input controller 110 monitors the amplitude of the switch voltage V_{SW} at the switching terminal 112. At 218, in response to detecting the zero amplitude of the switch voltage V_{SW} at the switching terminal 112, the input controller 110 activates the primary switch 108 to provide ZVS of the primary switch 108. In the example of FIG. 3, the primary switch 108 is activated at a time T5. Accordingly, the flow diagram 200 proceeds from 218 back to 202, such that the process repeats. In the example of FIG. 3, the amplitude changes of the switch voltage V_{SW} are thus demonstrated as repeating for another cycle of activation of the primary and secondary switches 108 and 116 to deliver power to the circuit output 120.

Based on the operation of the quasi-resonant flyback voltage regulator system 100, the output controller 118 communicates a request to the input controller 110 for the switching stage 102 to provide more power to the output stage 104 based on the currents provided in the transformer 106. Particularly, by activating and deactivating the secondary switch 116 to generate the reflected current I_{RFL} in the primary winding L_{PRI}, and thus providing the zero amplitude switch voltage V_{SW} as a trigger condition to activate the primary switch 108, the input controller 110 and the output controller 118 can communicate with each other through the transformer 106 to properly regulate the amplitude of the output voltage V_{OUT}, as described in steps 202 through 218. Therefore, the quasi-resonant flyback voltage regulator system 100 can operate to provide coordination of the activation of the primary and secondary switches 108 and 116 to regulate the output voltage V_{OUT} without additional circuitry that provides dedication communication signals between the input controller 110 and the output controller 118.

The operation of the quasi-resonant flyback voltage regulator system 100 is described above for an amplitude of the input voltage V_{IN} that is sufficiently large to provide for the communication between the input controller 110 and the output controller 118 to properly regulate the amplitude of the output voltage V_{OUT} via the currents through the transformer 106. However, as described in greater detail herein, the operation of the quasi-resonant flyback voltage regulator system 100 can be modified to accommodate a situation in which the input voltage V_{IN} decreases less than the reflected voltage V_{RFL}, which could otherwise result in erroneous operation of the quasi-resonant flyback voltage regulator system 100, such as an erroneous activation of the primary switch.

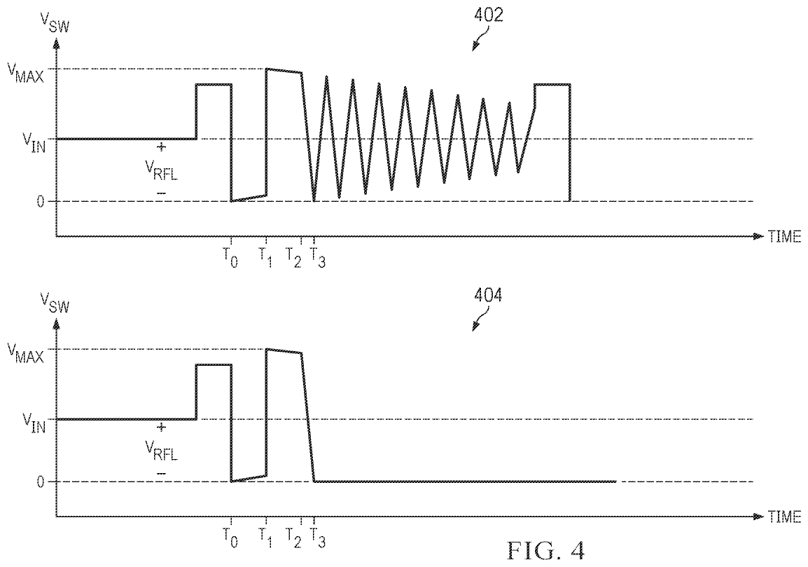

FIG. 4 is another example of a timing diagram 400. The timing diagram 400 includes a first portion 402 and a second portion 404. The timing diagram 400 describes operation of the quasi-resonant flyback voltage regulator system 100. Reference is to be made to the example of FIGS. 1 and 2 in the following description of the example of FIG. 4.

As described above, at 202 in the flow diagram 200, the primary switch 108 is activated in response to the input controller 110 detecting a zero amplitude of a switch voltage V_{SW} at the switching terminal 112. In the first and second portions 402 and 404 of the timing diagram 400, the step 202 occurs at a time T₀ in which the switch voltage V_{SW} decreases to zero. Therefore, the primary current I_{PRI} is provided through the primary winding L_{PRI} of the transformer 106. The switch voltage V_{SW} begins to slightly increase after the time T₀ in the timing diagram 300 based on the charging of the total capacitance C_{SW} of the switching terminal 112. At 204 in the flow diagram 200, the input controller 110 deactivates the primary switch 108 in response to an amplitude of the primary current I_{PRI} exceeding a threshold current amplitude to provide the secondary current I_{SEC} through the secondary winding L_{SEC} of the transformer 106. In the first and second portions 402 and 404 of the timing diagram 400, the step 204 occurs at a time T₁ in which the switch voltage V_{SW} increases significantly to an amplitude V_{MAX}.

At 206 in the flow diagram 200, the secondary current I_{SEC} charges the output capacitor that provides the output voltage V_{OUT} at the circuit output 120 until the amplitude of the secondary current I_{SEC} decreases to approximately zero, resulting in ringing of the primary voltage V_{PRI} based on the resonator 122. In the first and second portions 402 and 404 of the timing diagram 400, the step 206 occurs at a time T₂ in which the switch voltage V_{SW} decreases significantly. In the first and second portions 402 and 404 of the timing diagram 400, the switch voltage V_{SW} decreases to an amplitude that is less than the input voltage V_{IN} by the reflected voltage amplitude V_{RFL} at a time T₃.

In the example of FIG. 4, the input voltage V_{IN} is demonstrated as being less than or approximately equal to the amplitude of the reflected voltage amplitude V_{RHL}. As described above, at steps 202 and 218 of the flow diagram 200, the output controller 118 monitors the ringing of the switch voltage V_{SW} at the switching terminal 112 and activates the primary switch 108 in response to detecting a zero amplitude of the switch voltage V_{SW}. Therefore, if the reflected voltage amplitude V_{RFL} is greater than the input voltage V_{IN}, then the switch voltage V_{SW} can decrease to approximately zero at the first decrease of the switch voltage V_{SW} of the ringing resulting from resonator 122. Accordingly, instead of operating as intended, as demonstrated in the example of FIG. 3 and in the first portion 402 of the timing diagram 400, the zero voltage amplitude of the switch voltage V_{SW} could be detected by the input controller 110, resulting in an erroneous activation of the primary switch 108.

The erroneous activation of the primary switch 108 is demonstrated at the time T₃ in the second portion 404 of the timing diagram 400. Instead of continuing to ring, as demonstrated in the first portion 402, the switch voltage V_{SW} is maintained at an amplitude of zero while the primary switch 108 is activated. The result of the erroneous activation of the primary switch 108 is that the output voltage V_{OUT} is no longer regulated, such that the output voltage V_{OUT} can begin to increase in response to the secondary current I_{SEC}, as induced by the primary current I_{PRI} based on the activation of the primary switch 108. Additionally, the increase in the output voltage V_{OUT} could result in an unsafe amplitude, potentially resulting in damage to the quasi-resonant flyback voltage regulator system 100, based on the disabling of the control scheme described above. In other words, because of the erroneous activation of the primary switch 108, the control scheme that provides for normal operation of the quasi-resonant flyback voltage regulator system 100, as described in the examples of FIGS. 2 and 3, becomes disabled and unrecoverable. Accordingly, the quasi-resonant flyback voltage regulator system 100 could cease to operate, and could become irreparably damaged.

Because of the potential for the erroneous activation of the primary switch 108, the quasi-resonant flyback voltage regulator system 100 can include a control mechanism to ensure that the ringing of the switch voltage V_{SW} does not result in an erroneous activation of the primary switch 108 that can result in loss of the control scheme of the quasi-resonant flyback voltage regulator system 100. As a first example, the input controller 110 can include circuitry that can provide blanking of at least one trough of the ringing of the switch voltage V_{SW}. As a second example, the output controller 118 can include an additional control loop that can detect the erroneous activation of the primary switch 108, and can facilitate deactivation of the primary switch 108 to maintain the control scheme for regulating the output voltage V_{OUT}. In this manner, the quasi-resonant flyback voltage regulator system 100 can be configured to provide the control scheme for regulating the output voltage V_{OUT} in a robust manner, despite variations in the amplitude of the input voltage V_{IN}, as described in greater detail herein.

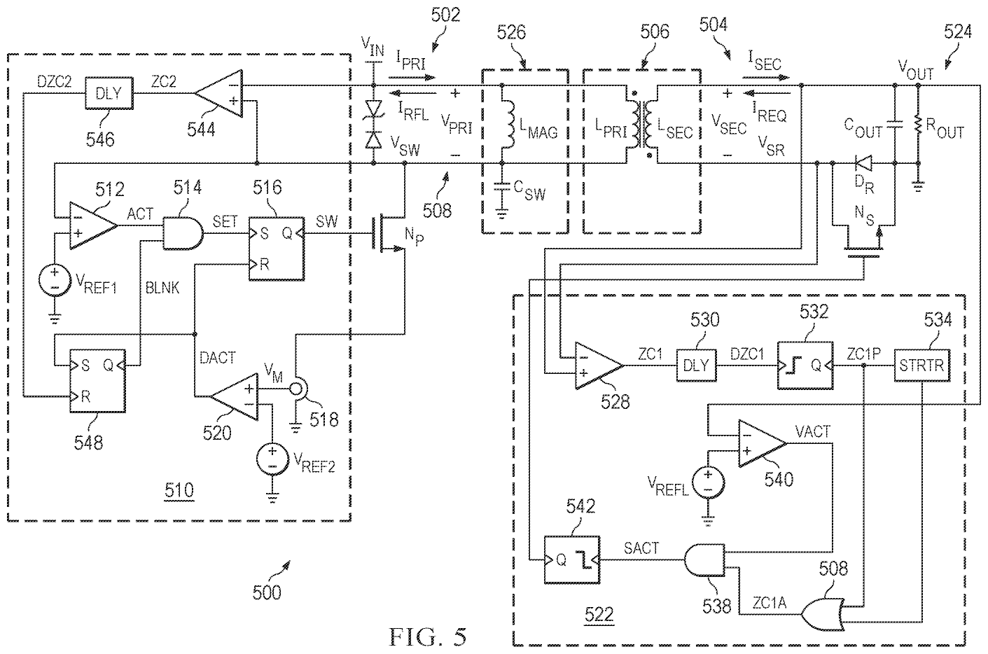

FIG. 5 is an example circuit diagram of a quasi-resonant flyback voltage regulator system 500. The quasi-resonant flyback voltage regulator system 500 can correspond to a first example of the quasi-resonant flyback voltage regulator system 100. Therefore, reference is to be made to the example of FIGS. 1-3 in the following description of the example of FIG. 5. As described in greater detail herein, the quasi-resonant flyback voltage regulator system 500 can implement blanking of at least one trough of the ringing of the switch voltage V_{SW} to mitigate the erroneous activation of the primary switch in response to the reflected voltage V_{RFL} being greater than the input voltage V_{IN}.

The quasi-resonant flyback voltage regulator system 500 includes a switching stage 502 having a switch voltage V_{SW}, an output stage 504, and a transformer 506. In the example of FIG. 5, the switching stage 502 includes a primary switch, demonstrated as an NFET N_{P} having a drain coupled to a switching terminal 508, a set of opposing diodes interconnecting the input voltage V_{IN} and the switching terminal 508, and an input controller 510. The input controller 510 is configured to periodically activate the primary switch N_{P} to provide a primary current I_{PRI} from the input voltage V_{IN} through a primary winding L_{PRI} of the transformer 506.

In the example of FIG. 5, the input controller 510 includes a switching terminal comparator 512 having an inverting input coupled to the switching terminal 508 and a non-inverting input that receives a reference voltage V_{REF1}. The reference voltage V_{REF1} can be very low (e.g., close to zero), such that the switching terminal comparator 512 can provide an activation signal ACT in response to the switch voltage V_{SW} decreasing to approximately zero. The activation signal ACT is provided to a first input of an AND-gate 514, with the AND-gate 514 having an output that provides a set signal SET to the set input of an activation latch 516, demonstrated as an SR latch. The activation latch 516 has a Q output that provides an output signal SW to the primary switch N_{P}. Therefore, in response to the activation signal ACT and a second input to the AND-gate 514 being asserted, the set signal SET sets the activation latch 516 to assert the signal SW to activate the primary switch N_{P}. Accordingly, the primary switch N_{P} is activated in response to an approximate zero amplitude of the switch voltage V_{SW} on the switching terminal 508.

The input controller 510 also includes a current monitor 518 that is coupled to the source of the NFET N_{P} and to a low-voltage rail (e.g., ground). The current monitor 518 thus provides a monitor voltage V_{M} that is associated with the amplitude of the primary current I_{PRI} to a non-inverting input of a switch comparator 520 that also includes an inverting input that is provided a reference voltage V_{REF2}. The reference voltage V_{REF2} can have an amplitude that is associated with a sufficient amplitude of the primary current I_{PRI}. Therefore, in response to the primary current I_{PRI} having an amplitude that results in the monitor voltage V_{M} being greater than the reference voltage V_{REF2}, the switch comparator 520 can provide a deactivation signal DACT that is provided to the reset input of the activation latch 516. Therefore, in response to the deactivation signal DACT being provided to the activation latch 516, the activation latch 516 can de-assert the signal SW to deactivate the primary switch N_{P}.

In the example of FIG. 5, the output stage 504 includes a rectifier diode D_{R}, a secondary switch, demonstrated as an NFET N_{S}, and an output controller 522. The secondary switch N_{S} is demonstrated as an arranged in anti-parallel with rectifier diode D_{R}, such that the secondary switch N_{S} has a drain coupled to the cathode of the rectifier diode D_{R} and a source coupled to the anode of the rectifier diode D_{R}. The rectifier diode D_{R} can be arranged to facilitate the flow of a secondary current I_{SEC} that is induced in the secondary winding L_{SEC} of the transformer 506 and is provided to a circuit output 524 to charge an output capacitor C_{OUT} to provide the output voltage V_{OUT} to a load, demonstrated as a load resistor R_{OUT}. For example, as described in greater detail herein, the secondary current I_{SEC} can be provided in response to deactivation of the primary switch N_{P}, such as in response to an amplitude of the primary current I_{PRI}, and thus based on the energy provided in the primary winding L_{PRI} by the primary current I_{PRI}. The secondary current I_{SEC} can thus flow from ground, through the rectifier diode D_{R} in forward bias, and through the secondary winding L_{SEC} to charge the output capacitor C_{OUT} to provide the output voltage V_{OUT} at the circuit output 524.

In response to the secondary current I_{SEC} decreasing to the approximately zero, a voltage V_{PRI} across the primary winding L_{PRI} can begin to ring based on a resonator 526 that is formed by a magnetizing inductance L_{MAG} associated with the transformer 506 and by a total capacitance C_{SW} associated with the switching terminal 508. The ringing associated with the voltage V_{PRI} can be reflected to the secondary winding L_{SEC}. The output controller 522 can be configured to monitor the amplitude of the output voltage V_{OUT}, and can monitor ringing at a voltage V_{SEC} across the secondary winding L_{SEC} that is based on the voltage V_{PRI}.

In the example of FIG. 5, the output controller 522 includes a secondary ringing comparator 528 that is configured to monitor the ringing of the secondary voltage V_{SEC}. The secondary ringing comparator 528 includes an inverting input and a non-inverting input that are coupled to opposite terminals of the secondary winding L_{SEC}, and thus to the circuit output 524 (to a non-inverting input of the secondary ringing comparator 528) and to a terminal coupled to the cathode of the rectifier diode D_{R} (to an inverting input of the secondary ringing comparator 528) having a voltage V_{SR}. Therefore, the secondary ringing comparator 528 is configured to generate a zero-crossing signal ZC1 in response to the voltage V_{SR} decreasing less than the output voltage V_{OUT} during ringing of the secondary voltage V_{SEC}. The zero-crossing signal ZC1 is delayed by a quarter of a period of the ringing of the primary and secondary voltages V_{PRI} and V_{SEC}, based on known parameters of the resonator 526, by an on-delay element 530. Therefore, the rising-edge of the zero-crossing signal ZC1 is delayed by the on-delay element 530 to generate a delayed zero-crossing signal DZC1. By delaying the zero-crossing signal ZC1 by one quarter of the period of the period of the ringing of the primary and secondary voltages V_{PRI} and V_{SEC}, the delayed zero-crossing signal DZC1 can correspond approximately to a time that the voltage V_{SR} is at a trough of the ringing, and therefore at a time when the voltage across the secondary switch N_{S} is approximately zero.

The delayed zero-crossing signal DZC1 is provided to a one-shot element 532 that is configured to provide a one-shot output pulse ZCIP in response to the delayed zero-crossing signal DZC1. The one-shot output pulse ZCIP is provided to a starter circuit 534 and to a first input of an OR-gate 536. The starter circuit 534 can include a timer that is configured to provide a copy of the one-shot output pulse ZCIP to the second input of the OR-gate 536 after expiration of the timer without receiving the one-shot output pulse ZCIP, such as based on a short time of the ringing in response to a light load of the quasi-resonant flyback voltage regulator system 500 (e.g., a low resistance value of the load R_{OUT}). Therefore, the OR-gate 536 is configured to provide a zero-crossing activation signal ZC1A in response to the one-shot output pulse ZCIP from either the one-shot element 532 or from the starter circuit 534.

The zero-crossing activation signal ZC1A is provided to a first input of an AND-gate 538. The output controller 522 also includes an output voltage comparator 540 that is configured to monitor the amplitude of the output voltage V_{OUT}. The output voltage comparator 540 has an inverting input that receives the output voltage V_{OUT} and a non-inverting input that is provided a low output reference voltage V_{REFL}. The low output reference voltage V_{REFL} can correspond to a voltage amplitude that is an unacceptably low amplitude of the output voltage V_{OUT}, and thus necessitates an additional cycle of energy from the switching stage 502. The output voltage comparator 540 thus provides an activate signal VACT in response to the output voltage V_{OUT} decreasing less than the low output reference voltage V_{REFL}.

The activate signal VACT is provided to a second input of the AND-gate 538. Therefore, in response to the activate signal VACT and the zero-crossing activation signal ZC1A, the AND-gate 538 generates a secondary switch activation signal SACT that is provided to a one-shot element 542 having an output that is provided to the gate of the secondary switch N_{S}. The one-shot element 542 can have an activation time duration that is predetermined (e.g., based on an applied voltage (not shown)). Therefore, the AND-gate 538 asserts the secondary switch activation signal SACT in response to the output voltage V_{OUT} decreasing to less than the low output reference voltage V_{REFL} and in response to an amplitude of the voltage V_{SR} being at a trough of the ringing corresponding to approximately zero volts across the secondary switch N_{S}. Accordingly, the secondary switch activation signal SACT activates the secondary switch N_{S} via the one-shot element 542 at a time of approximately zero volts across the secondary switch N_{S} to provide ZVS of the secondary switch N_{S}. The activation of the secondary switch N_{S} facilitates the process of requesting more power from the switching stage 502, as described in greater detail herein.

Upon activation, the secondary switch N_{S} can conduct a request current I_{REQ} from the circuit output 524, through the secondary winding L_{SEC}, and through the secondary switch N_{S}. Thus, the request current I_{REQ} flows in a direction opposite the secondary current I_{SEC}. As described above, the one-shot element 542 can be activate the secondary switch N_{S} for a predefined time duration before deactivation, such as sufficient to build a large enough amplitude of the request current I_{REQ} in the secondary winding L_{SEC}. After the predefined time duration, the secondary switch N_{S} is deactivated by the one-shot element 542 to provide a reflected current I_{RFL} through the primary winding L_{PRI} of the transformer 506 opposite the direction of the primary current I_{PRI}. The reflected current I_{RFL} thus conducts current from the switching terminal 508, thereby discharging the total capacitance C_{SW} of the switching terminal 508 to reduce the switch voltage V_{SW} to approximately zero. As described above, in response to the switch voltage V_{SW} having an amplitude of zero, the input controller 510 can activate the primary switch N_{P} again, thus repeating the process described above.

As described above, the quasi-resonant flyback voltage regulator system 500 can implement blanking of at least one trough of the ringing of the switch voltage V_{SW} to mitigate the erroneous activation of the primary switch in response to the reflected voltage V_{RHL} being greater than the input voltage V_{IN}. In the example of FIG. 5, the input controller 510 includes a primary ringing comparator 544 that is configured to monitor the ringing of the primary voltage V_{PRI}. The primary ringing comparator 544 includes an inverting input and a non-inverting input that are coupled to opposite terminals of the primary winding L_{PRI}, and thus to the input voltage V_{IN} (to an inverting input of the primary ringing comparator 544) and to the switching terminal 508 (to a non-inverting input of the primary ringing comparator 544) having the switch voltage V_{SW}. Therefore, the primary ringing comparator 544 is configured to generate a zero-crossing signal ZC2 in response to the switch voltage V_{SW} increasing greater than the input voltage V_{IN} during ringing of the primary voltage V_{PRI}.

The zero-crossing signal ZC2 is delayed by an on-delay element 546. As an example, the on-delay element 546 can provide a sufficient amount of delay of the rising-edge of the zero-crossing signal ZC2 at the time T₂ to surpass the time T₃ in the examples of FIGS. 3 and 4, and thus past the first trough of the ringing of the primary voltage V_{PRI}. Therefore, the rising-edge of the zero-crossing signal ZC2 is delayed by the on-delay element 546 to generate a delayed zero-crossing signal DZC2. By delaying the zero-crossing signal ZC2 by one quarter of the period of the period of the ringing of the primary and secondary voltages V_{PRI} and V_{SEC}, the delayed zero-crossing signal DZC2 can correspond approximately to a time that the voltage V_{SW} is at a peak of the ringing.

The delayed zero-crossing signal DZC2 is provided to a reset input of a blanking latch 548. The blanking latch 548 also includes a set input that receives the deactivation signal DACT from the switch comparator 520, and includes an inverted Q output that provides a blanking signal BLNK to a second input of the AND-gate 514. As described above, during activation of the primary switch N_{P}, in response to the primary current I_{PRI} having an amplitude that results in the monitor voltage V_{M} being greater than the reference voltage V_{REF2}, the switch comparator 520 provides the deactivation signal DACT to the reset input of the activation latch 516 to de-assert the signal SW to deactivate the primary switch N_{P}. The deactivation signal DACT also thus sets the blanking latch 548, thereby de-asserting the blanking signal BLNK. The de-asserted blanking signal BLNK thus ensures that the AND-gate 514 cannot assert the set signal SET in response to a zero amplitude of the switch voltage V_{SW}.

As described above, the on-delay element 546 can provide a sufficient amount of delay of the rising-edge of the zero-crossing signal ZC2 at the time T₂ to surpass the time T₃ in the examples of FIG. 4, and thus past the first trough of the ringing of the primary voltage V_{PRI}. Therefore, at the time T₃ in the example of FIG. 4, the reflected voltage V_{RFL} can be less than the input voltage V_{IN}, thereby causing the switch voltage V_{SW} to decrease to approximately zero volts. As a result, the activation signal ACT is provided from the switching terminal comparator 512 to the first input of an AND-gate 514. However, because the blanking signal BLNK is de-asserted, the AND-gate 514 does not assert the signal SW to set the activation latch 516. Therefore, the input controller 510 provides blanking of the first trough of the ringing of the primary voltage V_{PRI}, thereby preventing an erroneous activation of the primary switch N_{P} based on the amplitude of the reflected voltage V_{RFL} being greater than the input voltage V_{IN}.

In response to the delayed zero-crossing signal DZC2 being asserted, the blanking latch 548 is reset, thereby asserting the blanking signal BLNK. The asserted blanking signal BLNK is thus provided to the second input of the AND-gate 514 to thereby facilitate assertion of the switch signal SW to set the activation latch 516 in response to the switch voltage V_{SW} decreasing to approximately zero. Accordingly, the primary switch N_{P} can be activated in response to the zero amplitude of the switch voltage V_{SW}, as intended, after the first trough of the ringing of the primary voltage V_{PRI}. While the example of FIG. 5 demonstrates a manner of providing blanking of the first trough, the circuit can be modified to provide blanking of additional troughs after the first trough, as well. As a result, the quasi-resonant flyback voltage regulator system 500 is a robust example of implementing coordinated ZVS of the primary and secondary switches N_{P} and N_{S} based communication via currents provided through the transformer 506, and thus absent dedicated signal transfer between the switching stage 502 and the output stage 504.

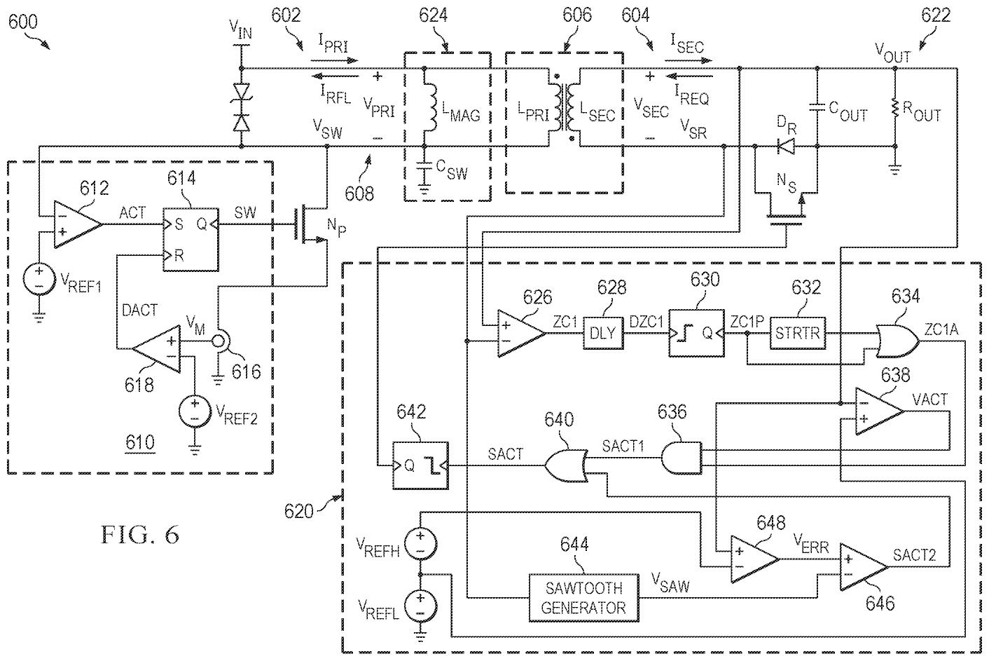

FIG. 6 is an example circuit diagram of a quasi-resonant flyback voltage regulator system 600. The quasi-resonant flyback voltage regulator system 600 can correspond to a first example of the quasi-resonant flyback voltage regulator system 100. Therefore, reference is to be made to the example of FIGS. 1-3 in the following description of the example of FIG. 6. As described in greater detail herein, the quasi-resonant flyback voltage regulator system 600 includes an additional control loop that can detect activation of the primary switch in response to the zero amplitude condition of the switch voltage V_{SW} resulting from the reflected voltage V_{RFL} being greater than the input voltage V_{IN}, and can facilitate deactivation of the primary switch in response.

The quasi-resonant flyback voltage regulator system 600 includes a switching stage 602 having a switch voltage V_{SW}, an output stage 604, and a transformer 606. In the example of FIG. 6, the switching stage 602 includes a primary switch, demonstrated as an NFET N_{P} having a drain coupled to a switching terminal 608, a set of opposing diodes interconnecting the input voltage V_{IN} and the switching terminal 608, and an input controller 610. The input controller 610 is configured to periodically activate the primary switch N_{P} to provide a primary current I_{PRI} from the input voltage V_{IN} through a primary winding L_{PRI} of the transformer 606.

In the example of FIG. 6, the input controller 610 includes a switching terminal comparator 612 having an inverting input coupled to the switching terminal 608 and a non-inverting input that receives a reference voltage V_{REF1}. The reference voltage V_{REF1} can be very low (e.g., close to zero), such that the switching terminal comparator 612 can provide an activation signal ACT in response to the switch voltage V_{SW} decreasing to approximately zero. The activation signal ACT is provided to a set input of an activation latch 614, demonstrated as an SR latch. The activation latch 614 has a Q output that provides an output signal SW to the primary switch N_{P}. Therefore, in response to the activation signal ACT being asserted, the set signal SET sets the activation latch 614 to assert the signal SW to activate the primary switch N_{P}. Accordingly, the primary switch N_{P} is activated in response to an approximate zero amplitude of the switch voltage V_{SW} on the switching terminal 608.

The input controller 610 also includes a current monitor 616 that is coupled to the source of the NFET N_{P} and to a low-voltage rail (e.g., ground). The current monitor 616 thus provides a monitor voltage V_{M} that is associated with the amplitude of the primary current I_{PRI} to a non-inverting input of a switch comparator 618 that also includes an inverting input that is provided a reference voltage V_{REF2}. The reference voltage V_{REF2} can have an amplitude that is associated with a sufficient amplitude of the primary current I_{PRI}. Therefore, in response to the primary current I_{PRI} having an amplitude that results in the monitor voltage V_{M} being greater than the reference voltage V_{REF2}, the switch comparator 618 can provide a deactivation signal DACT that is provided to the reset input of the activation latch 614. Therefore, in response to the deactivation signal DACT being provided to the activation latch 614, the activation latch 614 can de-assert the signal SW to deactivate the primary switch N_{P}.

In the example of FIG. 6, the output stage 604 includes a rectifier diode D_{R}, a secondary switch, demonstrated as an NFET N_{S}, and an output controller 620. The secondary switch N_{S} is demonstrated as an arranged in anti-parallel with rectifier diode D_{R}, such that the secondary switch N_{S} has a drain coupled to the cathode of the rectifier diode D_{R} and a source coupled to the anode of the rectifier diode D_{R}. The rectifier diode D_{R} can be arranged to facilitate the flow of a secondary current I_{SEC} that is induced in the secondary winding L_{SEC} of the transformer 606 and is provided to a circuit output 622 to charge an output capacitor C_{OUT} to provide the output voltage V_{OUT} to a load, demonstrated as a load resistor R_{OUT}. For example, as described in greater detail herein, the secondary current I_{SEC} can be provided in response to deactivation of the primary switch N_{P}, such as in response to an amplitude of the primary current I_{PRI}, and thus based on the energy provided in the primary winding L_{PRI} by the primary current I_{PRI}. The secondary current I_{SEC} can thus flow from ground, through the rectifier diode D_{R} in forward bias, and through the secondary winding L_{SEC} to charge the output capacitor C_{OUT} to provide the output voltage V_{OUT} at the circuit output 622.

In response to the secondary current I_{SEC} decreasing to the approximately zero, a voltage V_{PRI} across the primary winding L_{PRI} can begin to ring based on a resonator 624 that is formed by a magnetizing inductance L_{MAG} associated with the transformer 606 and by a total capacitance C_{SW} associated with the switching terminal 608. The ringing associated with the voltage V_{PRI} can be reflected to the secondary winding L_{SEC}. The output controller 620 can be configured to monitor the amplitude of the output voltage V_{OUT}, and can monitor ringing at a voltage V_{SEC} across the secondary winding L_{SEC} that is based on the voltage V_{PRI}.

In the example of FIG. 6, the output controller 620 includes a secondary ringing comparator 626 that is configured to monitor the ringing of the secondary voltage V_{SEC}. The secondary ringing comparator 626 includes an inverting input and a non-inverting input that are coupled to opposite terminals of the secondary winding L_{SEC}, and thus to the circuit output 622 (to a non-inverting input of the secondary ringing comparator 626) and to a terminal coupled to the cathode of the rectifier diode D_{R} (to an inverting input of the secondary ringing comparator 626) having a voltage V_{SR}. Therefore, the secondary ringing comparator 626 is configured to generate a zero-crossing signal ZC1 in response to the voltage V_{SR} decreasing less than the output voltage V_{OUT} during ringing of the secondary voltage V_{SEC}. The zero-crossing signal ZC1 is delayed by a quarter of a period of the ringing of the primary and secondary voltages V_{PRI} and V_{SEC}, based on known parameters of the resonator 624, by an on-delay element 628. Therefore, the rising-edge of the zero-crossing signal ZC1 is delayed by the on-delay element 628 to generate a delayed zero-crossing signal DZC1. By delaying the zero-crossing signal ZC1 by one quarter of the period of the period of the ringing of the primary and secondary voltages V_{PRI} and V_{SEC}, the delayed zero-crossing signal DZC1 can correspond approximately to a time that the voltage V_{SR} is at a trough of the ringing, and therefore at a time when the voltage across the secondary switch N_{S} is approximately zero.

The delayed zero-crossing signal DZC1 is provided to a one-shot element 630 that is configured to provide a one-shot output pulse ZCIP in response to the delayed zero-crossing signal DZC1. The one-shot output pulse ZCIP is provided to a starter circuit 632 and to a first input of an OR-gate 634. The starter circuit 632 can include a timer that is configured to provide a copy of the one-shot output pulse ZCIP to the second input of the OR-gate 634 after expiration of the timer without receiving the one-shot output pulse ZCIP, such as based on a short time of the ringing in response to a light load of the quasi-resonant flyback voltage regulator system 600 (e.g., a low resistance value of the load R_{OUT}). Therefore, the OR-gate 634 is configured to provide a zero-crossing activation signal ZC1A in response to the one-shot output pulse ZCIP from either the one-shot element 630 or from the starter circuit 632.

The zero-crossing activation signal ZC1A is provided to a first input of an AND-gate 636. The output controller 620 also includes an output voltage comparator 638 that is configured to monitor the amplitude of the output voltage V_{OUT}. The output voltage comparator 638 has an inverting input that receives the output voltage V_{OUT} and a non-inverting input that is provided a low output reference voltage V_{REFL}. The low output reference voltage V_{REFL} can correspond to a voltage amplitude that is an unacceptably low amplitude of the output voltage V_{OUT}, and thus necessitates an additional cycle of energy from the switching stage 602. The output voltage comparator 638 thus provides an activate signal VACT in response to the output voltage V_{OUT} decreasing less than the low output reference voltage V_{REFL}.

The activate signal VACT is provided to a second input of the AND-gate 636. Therefore, in response to the activate signal VACT and the zero-crossing activation signal ZC1A, the AND-gate 636 generates a first secondary switch activation signal SACT1 that is provided to a first input of an OR-gate 640. The OR-gate 640 provides a secondary switch activation signal SACT to a one-shot element 642 having an output that is provided to the gate of the secondary switch N_{S}. The one-shot element 642 can have an activation time duration that is predetermined (e.g., based on an applied voltage (not shown)). Therefore, the AND-gate 636 asserts the secondary switch activation signal SACT in response to the output voltage V_{OUT} decreasing to less than the low output reference voltage V_{REFL} and in response to an amplitude of the voltage V_{SR} being at a trough of the ringing corresponding to approximately zero volts across the secondary switch N_{S}. Accordingly, the secondary switch activation signal SACT activates the secondary switch N_{S} via the one-shot element 642 at a time of approximately zero volts across the secondary switch N_{S} to provide ZVS of the secondary switch N_{S}. The activation of the secondary switch N_{S} facilitates the process of requesting more power from the switching stage 602, as described in greater detail herein.

Upon activation, the secondary switch N_{S} can conduct a request current I_{REQ} from the circuit output 622, through the secondary winding L_{SEC}, and through the secondary switch N_{S}. Thus, the request current I_{REQ} flows in a direction opposite the secondary current I_{SEC}. As described above, the one-shot element 642 can be activate the secondary switch N_{S} for a predefined time duration before deactivation, such as sufficient to build a large enough amplitude of the request current I_{REQ} in the secondary winding L_{SEC} to be reflected to the primary winding L_{PRI}. After the predefined time duration, the secondary switch N_{S} is deactivated by the one-shot element 642 to provide a reflected current I_{RFL} through the primary winding L_{PRI} of the transformer 606 opposite the direction of the primary current I_{PRI}. The reflected current I_{RFL}, thus conducts current from the switching terminal 608, thereby discharging the total capacitance C_{SW} of the switching terminal 608 to reduce the switch voltage V_{SW} to approximately zero. As described above, in response to the switch voltage V_{SW} having an amplitude of zero, the input controller 610 can activate the primary switch N_{P} again, thus repeating the process described above.

As described above, the output controller 620 includes an additional control loop that can detect activation of the primary switch N_{P} in response to the zero amplitude condition of the switch voltage V_{SW} resulting from the reflected voltage V_{RFL} being greater than the input voltage V_{IN}, and can facilitate deactivation of the primary switch N_{P} in response. The output controller 620 includes a sawtooth generator 644 that is configured to generate a sawtooth voltage V_{SAW} based on the voltage V_{SR}. The sawtooth voltage V_{SAW} is provided to an inverting input of an error comparator 646. The output controller 620 also includes an error amplifier 648 that is configured to generate an error voltage V_{ERR} based on the output voltage V_{OUT} (at a positive input) and a high output reference voltage V_{REFH} (at a negative input) that has an amplitude greater than the low output reference voltage V_{REFL}. In the example of FIG. 6, the high output reference voltage V_{REFH} is provided as referenced to the low output reference voltage V_{REFL}, and can thus be selected at a sufficient amplitude greater than the low output reference voltage V_{REFL}. For example, the high output reference voltage V_{REFH} can be greater than the intended maximum amplitude of the output voltage V_{OUT}. The error voltage V_{ERR} is provided to the non-inverting input of the error comparator 646. The error comparator 646 thus provides a second secondary switch activation signal SACT2 that is provided to a second input of the OR-gate 640.

Under normal operating conditions when the input voltage V_{IN} is greater than the reflected voltage V_{RHL}, the quasi-resonant flyback voltage regulator system 600 operates as described above and with reference to the examples of FIGS. 2 and 3. However, in response to the input voltage V_{IN} being less than the reflected voltage V_{RHL}, as described in greater detail herein, the control loop formed by the output voltage comparator 638 and the AND-gate 636 is disabled, and a second control loop formed by the sawtooth generator 644, the error comparator 646, and the error amplifier 648 is instead implemented. During normal operation, the output voltage V_{OUT} can be less than the high output reference voltage V_{REFH}. Therefore, the error voltage V_{ERR} generated by the error amplifier 648 can be negative, and thus always less than the sawtooth voltage V_{SAW}. Accordingly, the second secondary switch activation signal SACT2 can always remain low under normal operating conditions, thereby providing for operation of the control loop formed by the output voltage comparator 638 and the AND-gate 636 in controlling the coordination between the input controller 610 and the output controller 620.

In response to the switch voltage V_{SW} decreasing at the trough of the ringing of the primary voltage V_{PRI} to zero at the time T₃, the input controller 610 activates the primary switch N_{P}, as described above. Such an activation of the primary switch N_{P} would be problematic but for the second control loop formed by the sawtooth generator 644, the error comparator 646, and the error amplifier 648. As described above, such a premature activation of the primary switch N_{P} provides for the primary current I_{PRI} to again flow through the primary winding L_{PRI}, which can result in the secondary current I_{SEC} again being provided to the circuit output 622. However, in response to this premature activation of the primary switch N_{P}, given that the output capacitor C_{OUT} is already charged to provide sufficient amplitude of the output voltage V_{OUT}, the output voltage V_{OUT} increases.

The increase in the output voltage V_{OUT} results in an increase in the error voltage V_{ERR}, thereby providing a positive amplitude in response to an increase in the output voltage V_{OUT} greater than the high output reference voltage V_{REFH}. Therefore, in response to the sawtooth voltage V_{SAW} increasing greater than the error voltage V_{ERR}, the error comparator 646 can assert the second secondary switch activation signal SACT2. The second secondary switch activation signal SACT2 provided to the OR-gate 640 therefore results in the OR-gate 640 asserting the secondary switch activation signal SACT, which activates the secondary switch N_{S} via the one-shot element 642.

As described above, when the primary switch N_{P} activates prematurely in response to the input voltage V_{IN} being less than the reflected voltage V_{RHL}, the normal operating control scheme fails to deactivate the primary switch N_{P}. Therefore, the activation of the secondary switch N_{S} via the one-shot element 642 by the second secondary switch activation signal SACT2 in the second control loop therefore occurs concurrently with an activation state of the primary switch N_{P}. Accordingly, the primary and secondary switches N_{P} and N_{S} are concurrently activated, which results in a short-circuit condition of the transformer 606. As a result, the primary current I_{PRI} increases significantly based on the short-circuit condition of the transformer 606.

However, such a significant increase in the amplitude of the primary current I_{PRI} results in deactivation of the primary switch N_{P}. Particularly, in the example of FIG. 6, the significant increase in the amplitude of the primary current I_{PRI} results in the monitor voltage V_{M} provided by the current monitor 616 increasing significantly, thus increasing in amplitude greater than the reference voltage V_{REF2}. Accordingly, the switch comparator 618 asserts the deactivation signal DACT, thereby resetting the activation latch 614 and deactivating the primary switch N_{P}. Therefore, the primary switch N_{P} can be deactivated to mitigate an excessive increase of the output voltage V_{OUT} to an unsafe amplitude, resulting in continued regulation of the amplitude of the output voltage V_{OUT}.

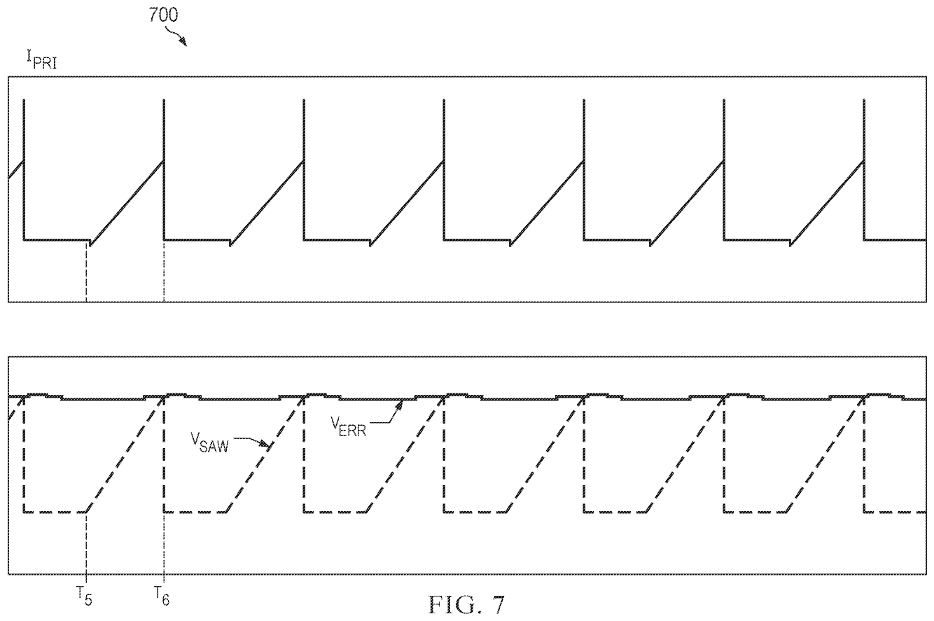

The quasi-resonant flyback voltage regulator system 600 can continue to operate via the second control loop formed by the sawtooth generator 644, the error comparator 646, and the error amplifier 648 so long as the input voltage V_{IN} remains less than the reflected voltage V_{RFL}. FIG. 7 is another example of a timing diagram 700. The timing diagram 700 corresponds to operation of the second control loop formed by the sawtooth generator 644, the error comparator 646, and the error amplifier 648 of the quasi-resonant flyback voltage regulator system 600. Therefore, reference is to be made to the example of FIG. 6 in the following description of the example of FIG. 7.

The timing diagram 700 demonstrates repeated periods of both the primary current I_{PRI} and the sawtooth voltage V_{SAW} relative to the error voltage V_{ERR}. At a time T₅, the primary switch N_{P} is activated in response to the switch voltage V_{SW} decreasing to approximately zero at the trough of the ringing of the primary voltage V_{PRI} (e.g., corresponding to the time T₃ in the example of FIG. 4). Therefore, at the time T₅, the primary current I_{PRI} begins to increase at a rate defined by the inductance of the primary winding L_{PRI}. In response, the voltage V_{SR} begins to increase, thereby causing the sawtooth voltage V_{SAW} to likewise linearly increase beginning at the time T₃. Based on the increased amplitude of the output voltage V_{OUT}, the error voltage is greater than nominal amplitude of the sawtooth voltage V_{SAW} until a time T₆. At the time T₀, the sawtooth voltage V_{SAW} increases greater than the error voltage V_{ERR}, thus resulting in the error comparator 646 asserting the second secondary switch activation signal SACT2. The second secondary switch activation signal SACT2 provided to the OR-gate 640 therefore results in the OR-gate 640 asserting the secondary switch activation signal SACT, which activates the secondary switch N_{S} via the one-shot element 642.

As described above, the activation of the secondary switch N_{S} occurs concurrently with an activation state of the primary switch N_{P}. Accordingly, the primary and secondary switches N_{P} and N_{S} are concurrently activated to provide a short-circuit condition of the transformer 606. As a result, the primary current I_{PRI} increases significantly beginning at the time T₀ based on the short-circuit condition of the transformer 606. However, the significant increase in the amplitude of the primary current I_{PRI} results in the monitor voltage V_{M} provided by the current monitor 616 increasing significantly, thus increasing in amplitude greater than the reference voltage V_{REF2}. Accordingly, the switch comparator 618 asserts the deactivation signal DACT immediately after the time T₆, thereby resetting the activation latch 614 and deactivating the primary switch N_{P}. Therefore, the primary switch N_{P} is deactivated to mitigate an excessive increase of the output voltage V_{OUT} to an unsafe amplitude, resulting in continued regulation of the amplitude of the output voltage V_{OUT}.

The timing diagram 700 thus demonstrates that the second control loop of the quasi-resonant flyback voltage regulator system 600 can continue to operate via the second control loop formed by the sawtooth generator 644, the error comparator 646, and the error amplifier 648 so long as the input voltage V_{IN} remains less than the reflected voltage V_{RFL}. Accordingly, the quasi-resonant flyback voltage regulator system 600 can continue to regulate the amplitude of the output voltage V_{OUT} even in response to the input voltage V_{IN} being less than the reflected voltage V_{RFL}. In response to the input voltage V_{IN} increasing to greater than the reflected voltage V_{RFL}, the second control loop formed by the sawtooth generator 644, the error comparator 646, and the error amplifier 648 can be disabled, and the primary control loop formed by the output voltage comparator 638 and the AND-gate 636 can once again resume control of the operation of the quasi-resonant flyback voltage regulator system 600. Accordingly, the quasi-resonant flyback voltage regulator system 600 is another example of a robust manner of regulating the output voltage V_{OUT} based on coordinating the switching of the primary and secondary switches N_{P} and N_{S} in response to current flow through the transformer 606.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

In this description, a device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof. Furthermore, a circuit or device that is described herein as including certain components may instead be configured to couple to those components to form the described circuitry or device. For example, a structure described herein as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be configured to couple to at least some of the passive elements and/or the sources to form the described structure, either at a time of manufacture or after a time of manufacture, such as by an end-user and/or a third-party.

Modifications are possible in the described embodiments, and other embodiments are possible, within the scope of the claims.

What is claimed is:

1. An integrated circuit (IC) comprising:
a switching stage comprising a primary switch and an input controller, the input controller being configured to activate the primary switch to conduct a primary current in a primary winding of a transformer in response to a switch voltage at a switching terminal having an amplitude of zero, and to deactivate the primary switch to provide a secondary current in a secondary winding of the transformer based on the primary current; and
an output stage configured to provide an output voltage at an output in response to the secondary current, the output stage comprising a secondary switch and an output controller, the output controller being configured to:
activate the secondary switch to conduct a request current in the secondary winding in response to an amplitude of the output voltage and ringing of a primary voltage across the primary winding; and
deactivate the secondary switch to provide reflected current in the primary winding based on the request current to reduce the switch voltage to zero.

2. The IC of claim 1, wherein the input controller is configured to monitor the ringing of the primary voltage and to activate the primary switch in response to the switch voltage having an amplitude of approximately zero after at least one trough of the ringing of the primary voltage.

3. The IC of claim 1, wherein the output controller is configured to monitor the output voltage and to activate the secondary switch in response to the output voltage exceeding an output voltage threshold to provide for concurrent activation of the primary switch and the secondary switch, wherein the input controller is configured to deactivate the primary switch in response to the primary current exceeding a primary current threshold.

4. The IC of claim 1, wherein the input controller comprises:
a switch comparator configured to monitor an amplitude of the primary current and to generate a deactivate signal in response to the primary current exceeding a primary current threshold;
a switch terminal comparator configured to monitor an amplitude of the switch voltage and to generate an activate signal in response to the switch voltage decreasing to approximately zero; and
an activation latch configured to control the primary switch, wherein the activate signal is provided to a set input of the activation latch and the deactivate signal is provided to a reset input of the activation latch.

5. The IC of claim 4, wherein the input controller further comprises:
a primary ringing comparator configured to monitor the primary voltage and to generate a zero-crossing signal in response to a decreasing zero-crossing of the primary voltage;
an on-delay element configured to generate a delayed zero-crossing signal by delaying the zero-crossing signal by a quarter of a period of the ringing of the primary voltage;
a blanking latch configured to cooperate with the activation latch to control the primary switch, wherein the deactivate signal is provided to a set input of the blanking latch and the delayed zero-crossing signal is provided to a reset input of the blanking latch.

6. The IC of claim 1, wherein the output controller comprises:
a secondary ringing comparator configured to monitor a secondary voltage across a secondary winding and to generate a zero-crossing signal in response to an increasing zero-crossing of the secondary voltage in response to the ringing of the primary voltage;
an on-delay element configured to generate a delayed zero-crossing signal by delaying the zero-crossing signal by a quarter of a period of the ringing of the primary voltage;
an output voltage comparator configured to monitor an amplitude of the output voltage and to generate an activate signal in response to the output voltage decreasing below an output voltage threshold; and
an AND-gate configured to control the secondary switch based on the activate signal and the delayed zero-crossing signal.

7. The IC of claim 6, wherein the output controller further comprises:
a sawtooth generator configured to generate a sawtooth voltage corresponding to the secondary voltage;
an error amplifier configured to generate an error voltage based on an amplitude of the output voltage relative to a reference voltage;
an error comparator configured to compare the error voltage and the sawtooth voltage and to generate a second activation signal in response to the sawtooth voltage being approximately equal to the error voltage; and
an OR-gate configured to control the secondary switch based on an output of the AND-gate or the second activation signal.

8. The IC of claim 6, further comprising:
a one-shot element configured to receive the delayed zero-crossing signal and to provide a zero-crossing pulse in response to the delayed zero-crossing signal;
a starter element configured to receive the zero-crossing pulse and to provide the zero-crossing pulse after expiration of a predefined timer; and
an OR-gate configured to receive the zero-crossing pulse from the one-shot element and from the starter element to provide the zero-crossing pulse to the AND-gate.

9. A circuit comprising:
a switching stage comprising:
a primary switch having a primary switch control input, a primary switch input, and a primary switch output, the primary switch input being coupled to a first terminal of a primary winding of a transformer; and
an input controller having a switching control input and a switching control output, the switching control input being coupled to the primary winding of the transformer and the control output being coupled to the primary switch input; and
an output stage having a circuit output, the output stage comprising:
a rectifier diode having an anode and a cathode, the anode being coupled to the circuit output and the cathode being coupled to a first terminal of a secondary winding of the transformer;
a secondary switch having a secondary switch control input, a secondary switch input, and a secondary switch output, the secondary switch input being coupled to the first terminal of the secondary winding of the transformer and the secondary switch output being coupled to the circuit output; and
an output controller having an output control input and an output control output, the output control input being coupled to a second terminal of the secondary winding of the transformer and the output control output being coupled to the secondary switch control input.

10. The circuit of claim 9, wherein the input controller comprises:
a current monitor having a monitor input and a monitor output, the monitor input being coupled to the primary switch output;
a switch comparator having a first switch comparator input, a second switch comparator input and a switch comparator output, the first switch comparator input being coupled to the monitor output and the second switch comparator input being coupled to a switch current reference voltage;
a switch terminal comparator having a first switch terminal comparator input, a second switch terminal comparator input and a switch terminal comparator output, the first switch terminal comparator input being coupled to a low reference voltage and the second switch terminal comparator input being coupled to the first terminal of the primary winding;
an activation AND-gate having a first AND-input, a second AND-input, and an AND-output, the first AND-input coupled to the switch terminal comparator output; and
an activation latch having an activation set input, an activation reset input, and an activation latch output, the activation set input being coupled to the AND-output and the activation reset input being coupled to the switch comparator output.

11. The circuit of claim 10, wherein the input controller further comprises:
a primary ringing comparator having a first primary ringing input, a second primary ringing input, and a primary ringing output, the first primary ringing input being coupled to the first terminal of the primary winding, the second primary ringing input being coupled to a second terminal of the primary winding;
an on-delay element comprising a delay input and a delay output, the delay input being coupled to the primary ringing output;
a blanking latch having a blanking set input, a blanking reset input, and a blanking latch output, the blanking set input being coupled to the switch comparator output, the blanking reset input being coupled to the primary ringing output, and the blanking latch output being coupled to the second AND-input.

12. The circuit of claim 9, wherein the output controller comprises:
a secondary ringing comparator having a first secondary ringing input, a second secondary ringing input, and a secondary ringing output, the first secondary ringing input being coupled to the second terminal of the secondary winding, the second secondary ringing input being coupled to the first terminal of the secondary winding;
an on-delay element comprising a delay input and a delay output, the delay input being coupled to the secondary ringing output;
a first one-shot element having a first one-shot input and a first one-shot output, the first one-shot input being coupled to the delay output;
an activation AND-gate having a first AND-input, a second AND-input, and an AND-output, the first AND-input being coupled to the first one-shot output;
an output voltage comparator having a first output comparator input, a second output comparator input, and an output comparator output, the first output comparator input being coupled to a low output threshold voltage, the second output comparator input being coupled to the circuit output, and the output comparator output being coupled to the second AND-input;
an activation OR-gate having a first OR-input, a second OR-input, and an OR-output, the first OR-input being coupled to the AND-output; and
a second one-shot element having a second one-shot input and a second one-shot output, the second one-shot input being coupled to the OR-output, the second one-shot output being coupled to the secondary switch control input.

13. The circuit of claim 12, wherein the output controller further comprises:
a sawtooth generator having a sawtooth input and a sawtooth output, the sawtooth input coupled to the first terminal of the secondary winding;
an error amplifier having a first error input, a second error input, and an error output, the first error input being coupled to the circuit output, the second error input being coupled to a configured to a high output threshold voltage; and
an error comparator having a first error comparator input, a second error comparator input, and an error comparator output, the first error comparator input being coupled to the error output, the second error comparator input being coupled to the sawtooth output, and the error comparator output being coupled to the second OR-input.

14. A quasi-resonant flyback voltage regulator system comprising:
a transformer comprising a primary winding and a secondary winding;
a switching stage comprising a primary switch and an input controller, the input controller being configured to activate the primary switch to conduct a primary current in the primary winding in response to a switch voltage at a switching terminal having an amplitude of zero, and to deactivate the primary switch to provide a secondary current in the secondary winding based on the primary current; and
an output stage configured to provide an output voltage at an output in response to the secondary current, the output stage comprising a secondary switch and an output controller, the output controller being configured to activate the secondary switch to conduct a request current in the secondary winding in response to an amplitude of the output voltage and ringing of a primary voltage across the primary winding, and to deactivate the secondary switch to provide reflected current in the primary winding based on the request current to reduce the switch voltage to zero.

15. The system of claim 14, wherein the input controller is configured to monitor the ringing of the primary voltage and to activate the primary switch in response to the switch voltage having an amplitude of approximately zero after at least one trough of the ringing of the primary voltage.

16. The system of claim 14, wherein the output controller is configured to monitor the output voltage and to activate the secondary switch in response to the output voltage exceeding an output voltage threshold to provide for concurrent activation of the primary switch and the secondary switch, wherein the input controller is configured to deactivate the primary switch in response to the primary current exceeding a primary current threshold.

17. The system of claim 14, wherein the input controller comprises:
a switch comparator configured to monitor an amplitude of the primary current and to generate a deactivate signal in response to the primary current exceeding a primary current threshold;
a switch terminal comparator configured to monitor an amplitude of the switch voltage and to generate an activate signal in response to the switch voltage decreasing to approximately zero; and
an activation latch configured to control the primary switch, wherein the activate signal is provided to a set input of the activation latch and the deactivate signal is provided to a reset input of the activation latch.

18. The system of claim 17, wherein the input controller further comprises:
a primary ringing comparator configured to monitor the primary voltage and to generate a zero-crossing signal in response to a decreasing zero-crossing of the primary voltage;
an on-delay element configured to generate a delayed zero-crossing signal by delaying the zero-crossing signal by a quarter of a period of the ringing of the primary voltage;
a blanking latch configured to cooperate with the activation latch to control the primary switch, wherein the deactivate signal is provided to a set input of the blanking latch and the delayed zero-crossing signal is provided to a reset input of the blanking latch.

19. The system of claim 14, wherein the output controller comprises:
a secondary ringing comparator configured to monitor a secondary voltage across a secondary winding and to generate a zero-crossing signal in response to an increasing zero-crossing of the secondary voltage in response to the ringing of the primary voltage;
an on-delay element configured to delay the zero-crossing signal by a quarter of a period of the ringing of the primary voltage;
an output voltage comparator configured to monitor an amplitude of the output voltage and to generate an activate signal in response to the output voltage decreasing below an output voltage threshold; and
an AND-gate configured to control the secondary switch based on the activate signal and the delayed zero-crossing signal.

20. The system of claim 19, wherein the output controller further comprises:
a sawtooth generator configured to generate a sawtooth voltage corresponding to the secondary voltage;
an error amplifier configured to generate an error voltage based on an amplitude of the output voltage relative to a reference voltage;
an error comparator configured to compare the error voltage and the sawtooth voltage and to generate a second activation signal in response to the sawtooth voltage being approximately equal to the error voltage; and
an OR-gate that is configured to control the secondary switch based on an output of the AND-gate or the second activation signal.
